(19) United States
(12) Patent Application Publication
(10) Pub. No.: US 2005/0103713 A1
(43) Pub. Date: May 19, 2005

(54) Devices with small-scale channels and the fabrication thereof by etching

(76) Inventors: J. Michael Ramsey, Chapel Hill, NC (US); Tony E. Haynes, Knoxville, TN (US); Leonard C. Feldman, Nashville, TN (US); David M. Zehner, Lenoir City, TN (US)

Correspondence Address: DANN, DORFMAN, HERRELL AND SKILLMAN;UT-BATTELLE, LLC, 1601 MARKET STREET, SUITE 2400, PHILADELPHIA, PA, 19103-2307, US

(21) Appl. No.: 10/903,310

(22) Filed: Jul. 30, 2004

Related U.S. Application Data
(60) Provisional application No. 60/491,223, filed on Jul. 30, 2003.

(51) Int. Cl. B01D 61/00

(52) U.S. Cl. 210/649; 216/2; 216/56; 257/618

(57) ABSTRACT

A method of producing a novel small-scale flow channel in a mesoscale analytic device from a solid multi-layered heterostructure with one or more channel layers sandwiched between adjoining barrier layers. The channel layer consists of a thin-film of a material of different composition than the barrier layers. At least one of the layers has a defined small-scale thickness. A channel or recess is formed in the heterostructure by etching away the channel layer to a preselected depth. The amount of the channel layer which is etched away determines the depth of the channel, and the thickness of the channel layer determines the width. A method of producing a die for forming a small-scale channel is also disclosed.

### RELATED APPLICATIONS

The present application is a continuation-in-part of provisional Application No. 60/491,223, filed Jul. 30, 2003 and relates to an alternative to the methods and apparatus described in pending U.S. patent application Ser. No. 10/629,790 filed Jul. 30, 2003. The subject matter of the pending Application No. 10/629,790 and the references cited therein are incorporated herein by reference.

### GOVERNMENT RIGHTS STATEMENT

This invention was made with government support under Contract No. DE-AC05-00OR22725 awarded by the United States Department of Energy to UT-Battelle, LLC. The government has certain rights in this invention.

### FIELD OF THE INVENTION

The present invention relates to fluidics, involving the act of transporting material through small-scale channels or conduits having microscaled dimensions or smaller and has particular application to nanoscale (<1000 nm) conduits and takes advantage of the dimensional control presently available in thin film technology for the fabrication of micro electronic devices.

### BACKGROUND OF THE INVENTION

Interest in microfabricated devices for chemical analysis and synthesis has grown substantially over the past decade, primarily because these “microchips” have the capability to provide information rapidly and reliably at low cost. Microchips having small-scale channels or conduits fabricated on planar substrates are advantageous for fluidic manipulation of small sample volumes, rapidly processing materials and integrating sample pretreatment and separation strategies. The ease with which materials can be manipulated and the ability to fabricate structures with interconnecting channels that have essentially no dead volume contribute to the high performance of these devices. In addition, integrated microfluidic systems provide significant automation advantages, as fluidic manipulations are subject to computer control. See for example U.S. Pat. Nos. 5,858,195 and 6,100,229 which are commonly owned with this application.

As set forth in our co-pending application, numerous efforts have been made toward providing sub micron channels, but new fabrication techniques must be developed if the full potential of fluidics in small-scale channels is to be realized.

This invention takes advantage of the dimensional control presently available in thin film technology for the fabrication of microelectronic devices. For example, silicon technology used to make the majority of today's semiconductor devices uses thin films of SiO₂ with thicknesses of only 2 nm and with a uniformity of better than 0.1 nm over a wafer that is 300 mm in diameter. A substrate wafer can contain a stack of thin films of different materials. Such a substrate is referred to as a multi-layer heterostructure. It may be any one of a number of different available types

More specifically, the present invention contemplates providing a multi-layer stack of thin films of different materials in which the thickness of the film is small-scale, namely microscale or smaller, and preferably nanoscale, and etching away the exposed edge portion of one of the layers in the stack to a depth corresponding to the depth of the channel or other opening desired to be fabricated.

For the purpose of the following description, the layers which are affected by the the etching material are called “channel layers” and the layers which are not affected by the etching material are called “barrier layers”.

### BRIEF DESCRIPTION OF THE DRAWINGS

FIG. 1 is a schematic diagram of a multi-layer heterostructure prior to the formation of small-scale channels;

FIG. 2 is an atomic resolution electron micrograph showing an example of extremely thick channel layer between two barrier layers;

FIG. 3A is a side view of a cut and polished heterostructure before etching;

FIG. 3B is a side view of the heterostructure after etching and mask removal;

FIGS. 4A, 4B and 4C are sequential views of the fabrication of intersecting microchannels from two heterostructures;

FIG. 5 is an exploded view of a heterostructure with a cover plate prepared for assembly;

FIG. 6 is an exploded view diagramming the use of two etched nanochannels to create a die for replicating the structure;

FIG. 7 is a chart summarizing the results of tests using two different types of heterostructures;

FIG. 8 is an atomic force microscope image of a nanoscale channel formed by selective chemical etching of a heterostructure;

FIGS. 9A-9E illustrate a sequence of steps involved in forming multiple buried channels;

FIG. 10 illustrates a sequence of steps in the formation of a buried nanochannel using FIB patterning;

FIGS. 11A-11C illustrate the formation of a dual tee intersection;

FIGS. 12A-12C illustrate the formation of a cross intersection;

FIG. 13 is a secondary electron image of an etched layered heterostructure with a focused ion beam (FIB) sectioned edge;

FIG. 14 is a secondary electron image of an etched heterostructure after disposition of an amorphous silicon dioxide film and sectioning with FIB;

FIGS. 15A-15D illustrate the steps in coupling a protein assembly to a buried channel through an access hole;

FIGS. 16A-16D illustrate the steps in preparing an addressable array of ion channel sensors;

FIG. 17 is a perspective view of an addressable ion channel array device; and

FIGS. 18A-18D are illustrations of a multi-layer heterostructure incorporating buried channels and multiple levels with level-to-level interconnections.

### DETAILED DESCRIPTION OF THE PREFERRED EMBODIMENTS

The present invention provides a nanoscale analytic device having a small-scale flow channel which is precisely dimensioned to either pass or block components in a test fluid based on the molecular size of the components. The flow area will pass components whose molecules are smaller in transverse cross-section than the flow area and will block passage of molecules whose cross-section is larger than the flow area, thereby enabling separation of the fluid into one phase with molecules larger than the flow area and a remaining phase which has molecules smaller in cross-section than the flow area.

The device is formed from a heterostructure composed of multiple layers, in which selected layers consist of a material which is different from other layers. The heterostructure has an exposed surface which exposes the multiple layers of the heterostructure and an etching material is applied to that surface to etch away the exposed marginal portion of one of the layers without affecting the layers on either side of the one layer. The composition of the one layer is such that the etching material is effective to eat away the marginal portion of the layer and the composition of the adjoining layers is such as to be unaffected by the etching material. It is possible to control the depth of the marginal portion which is etched away by controlling the conditions and the duration of the application of the etching material. Present technology enables these factors to be controlled by a computer within precise limits so that the depth of the marginal portion which is etched away may be in the nanometer range of measurement. By the same token, the width of the channel formed by the etching away of the marginal portion of the one layer is established by the thickness of the layer created by the use of modern thin-film technology, as used in the fabrication of silicon-on-insulator wafers and III-V compound semi-conductor superlattice wafers used to manufacture solid-state lasers.

By masking the exposed surface during the process of etching away the marginal portion of the intermediate layer, it is possible to create small-scale channels and openings having the desired dimensions. Existing methods for fabricating sub micron channels may be used to connect reservoirs to the opposite ends of the small-scale channel to create a “lab-on-a-chip” device. A similar technique may be used to create a die which may be used with other fabrication techniques to create small-scale conduits. The creation of the die mirrors the creation of channels by generating a protrusion between two recessed areas on the heterostructure's exposed surface. The protrusion has a width and height corresponding to the small-scale width and height of the channel discussed above, so that the process generates a die which may be used to create small-scale channels.

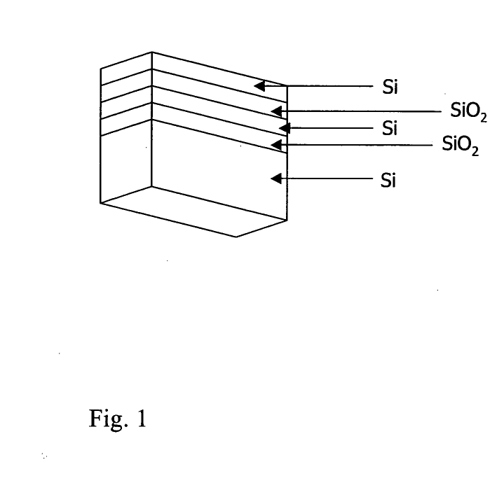

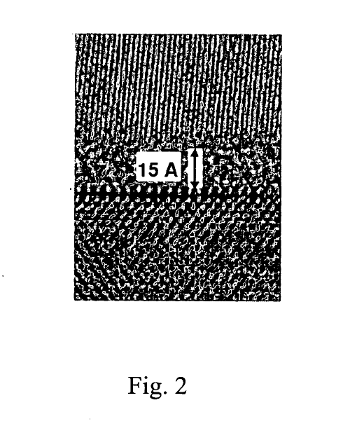

FIGS. 1-3 illustrate the method of the present invention. FIG. 1 illustrates a heterostructure consisting of five layers labeled Si, SiO₂, Si, SiO₂ and Si, respectively. FIG. 2 represents an atomic resolution micrograph of the multi-layer structure of FIG. 1 with the top layer labeled poly-Si. The thickness of the middle layer, SiO₂, is indicated by the dimension 15A which may represent a thickness of 1.5 nanometers. Current silicon technology uses thin films of SiO₂ with thicknesses of only 2 nanometers and with a uniformity of better than 0.1 nanometer over a wafer that is 300 milimeters in diameter. The stack of layers constitutes a multi-layer heterostructure and may contain thin films of different materials.

Nano-scale openings and channels may be created by selectively etching channel layers of the multi-layer heterostructure while leaving barrier layers intact. A preferred method for performing this operation consists of providing the heterostructure having channel and barrier layers of the desired thicknesses and then dicing or cleaving the heterostructure throughout its thickness to expose all of the layers on a lateral exposed face. Preferably, the surface exposed by the dicing or cleaving is polished to a mirror finish and mask material is applied to define the metes and bounds of the channel or opening to be formed. The surface is then subjected to an etching material, such as an etchant liquid or vapor that will dissolve material in selected channel layers, and will not dissolve material in the barrier layers of heterostructure. The duration of the application of the etchant to the exposed surface is precisely controlled to determine the amount of the marginal edge which is removed to form a flow channel. The configuration of the marginal portion of the layer which is etched away determines the configuration of the channel formed by the etching operation. Following the removal of the mask material, a cover is applied to the exposed surface to close the channel and provide a closed channel having a width determined by the thickness of the channel layer, a depth defined by the etching condition, and a length determined by the position of the masking material.

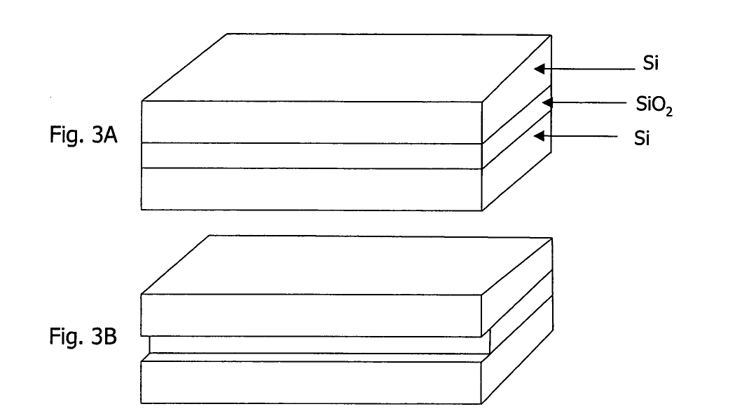

For use, the ends of the channel may be connected to fluid reservoirs using conventional microfluidics fabrication technology. FIG. 3A shows a three-layer heterostructure having layers labeled Si, SiO₂ and Si, respectively. After polishing, an etchant, such a buffered oxide etching solution is applied to selectively etch away the SiO₂ layer. The buffered oxide etching solution may contain HF, and the depth of the etch is determined by the concentration of the HF in the etching solution, the temperature of the solution and the stirring rate and duration of the etching. The resulting channel is illustrated in FIG. 3B.

Silicon multi-layer heterostructure substrates may be produced by a number of means including ion implantation of oxygen ions into crystal silicon or wafer bonding of thermally oxidized silicon surfaces. The substrate may have a single insulator layer or multiple layers may be prepared by bonding a number of wafers or implanting oxygen with multiple ion energies. Other suitable materials include Ill-V compound semiconductor multilayer heterostructures such as AlGaAs-on-GaAs prepared by a number of methods including chemical vapor deposition, vapor phase growth, etc., and combinations of metal oxide layers of differing composition such as PbTiO₃ on KTaO₄ prepared by sputter deposition, pulsed laser deposition, etc. Selective etchants are available for many materials combinations too numerous to list individually.

The preferred embodiment of the process refers to direct fabrication of nanochannels, but the same process can be used to produce a die, mole or stamp for replicating nanochannel structures by imprinting techniques. Imprinting may also be used to produce intersecting nanochannels by pressing different patterns onto the same surface such that patterns cross at desired points.

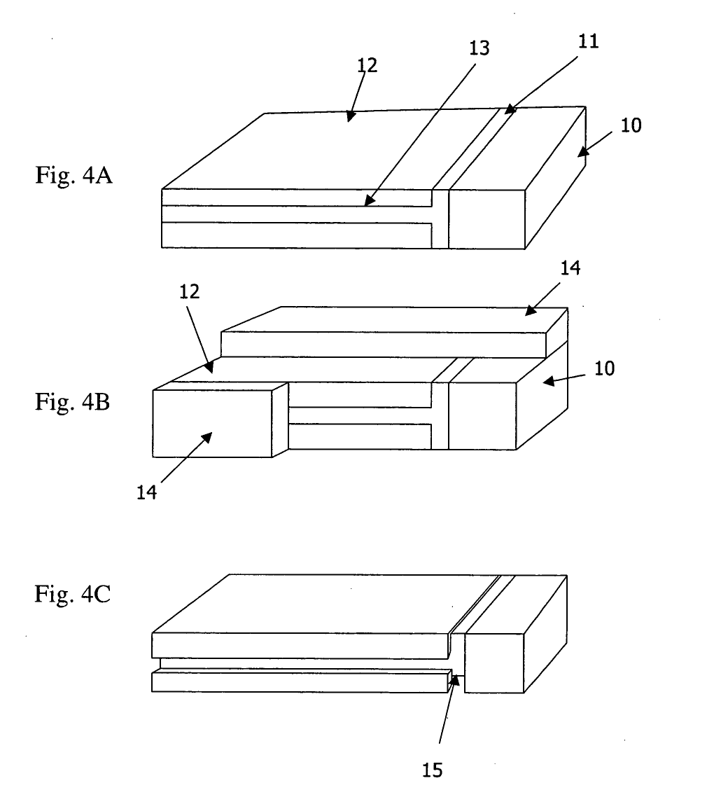

FIGS. 4A to 4C show perspective views of the possible steps that could be used to form a tee intersection of nanochannels using the fundamental process described above. A Si wafer 10 that has an oxidized surface to form an SiO₂ channel layer 11 of desired dimensions is bonded to the edge of a three layer heterostructure 12 having a central channel layer 13 to form a tee intersection of layers 11 and 13. A mask material 14, in this case a photoresist, is used to photolithographically define the areas of the channel layers that will be exposed to an etching solution. After etching and removal of resist, a nanofluidic tee intersection 15 remains. The lateral dimensions of the channels are determined by the thickness of the channel layers and the etching conditions. The length of the channels are determined the dimensions of the heterostructure assembly and the mask patterning. In general, the lengths will be of micrometer scale and the lateral dimensions of nanometer scale, i.e., <1000 nm. A cover member is bonded over the open nanochannels to form closed channels for fluidics application.

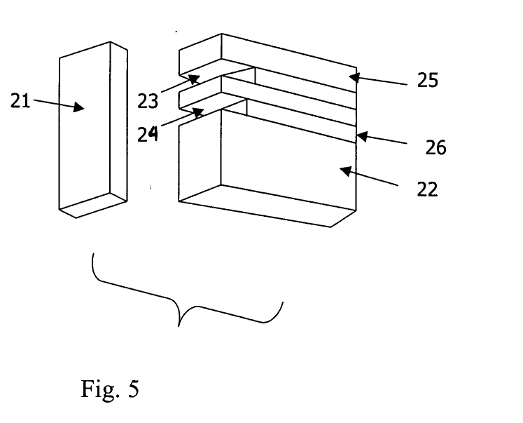

FIG. 5 illustrates the application of a cover member 21 to a heterostructure 22 having two flow channels 23 and 24 at the exposed ends of channel layers 25 and 26.

After forming nano-openings in the multilayer heterostructures, the etched heterostructures can be used as a die or stamp for molding or embossing nanometer scale openings in plastics or other moldable materials. In this case, the features in the multilayer heterostructure will be the compliment or negative of the pattern to be placed into the moldable material.

FIG. 6 illustrates an example of the formation of complementary dies from two different three-layer heterostructures. Each heterostructure was etched using the principles described above to heterostructures 21 and 22. Each heterostructure was etched using the principles described above. The heterostructure 21 is composed of three barrier layers 23, 24 and 25 with two intermediate channel layers 26 and 27. The heterostructure 22 is formed with three channel layers 28, 29 and 30 with two barrier layers 31 and 32 sandwiched between. FIG. 6 illustrates the form of the etched heterostructures to form complementary dies.

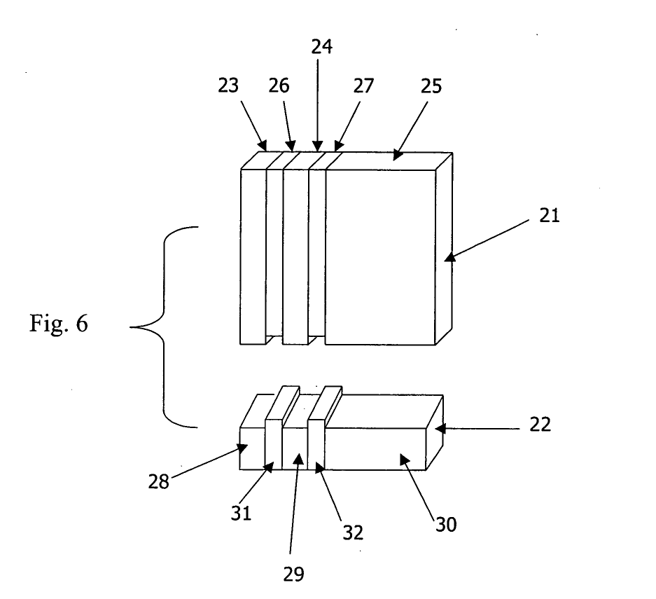

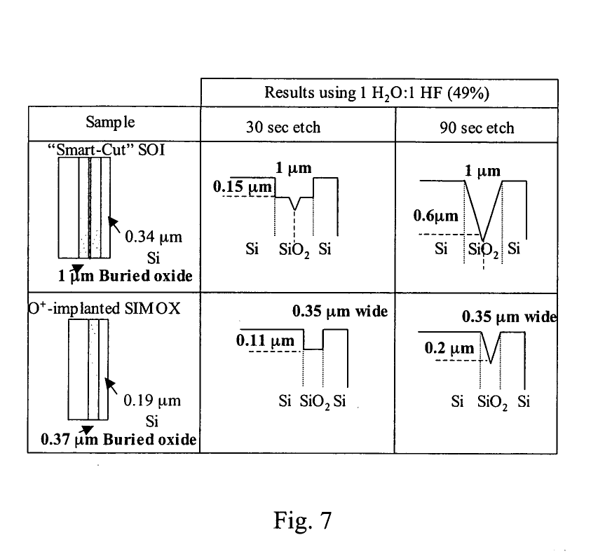

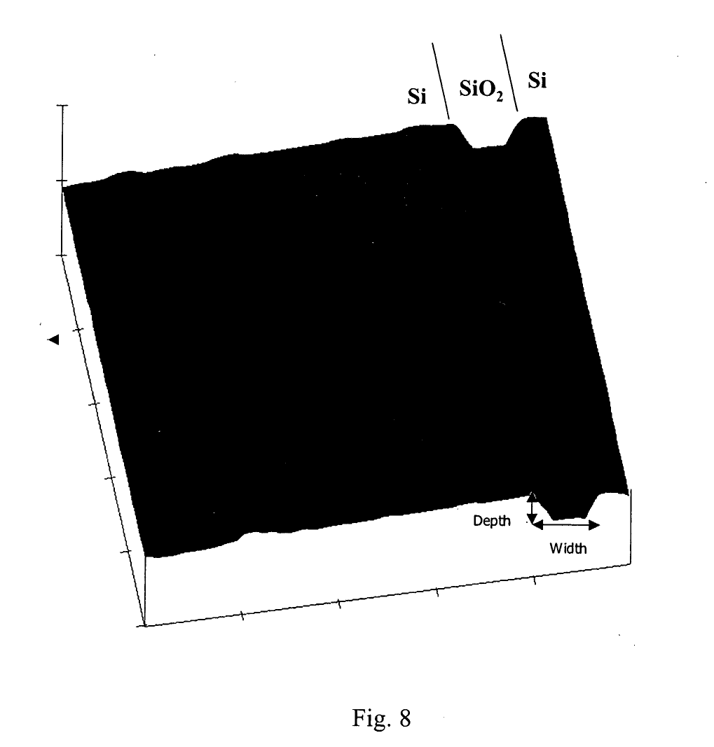

As examples of the formation of channels in heterostructures, a “Smart-Cut” silicon-on-insulator wafer and a SIMOX wafer were cut and polished to form a smooth and straight edge. Two samples of each wafer were subjected to an etching solution consisting of concentrated HF(49%) diluted 1:1 with water for a duration of 30s and 90s. The shapes and dimensions of the nano-openings formed by removal of the SiO₂ layers were determined by atomic force microscopy (AFM) and the results are shown in FIG. 7. The channel widths are from 110 nm to 370 nm. The maximum width of the nano-openings formed was equal to the thickness of the SiO₂ layers in all cases, namely 0.35 to approximately 1.0 μm. The depth of the nano-openings was proportional to the duration of the etching process, namely approximately 0.1 to 0.6 μm. Thus dimensions were consistent with expected results. FIG. 8 shows an AFM image of the SIMOX wafer 41 that was etched for 30 seconds. The Si barrier layers 42 and 43 sandwich the SiO₂ channel layer 44 between them.

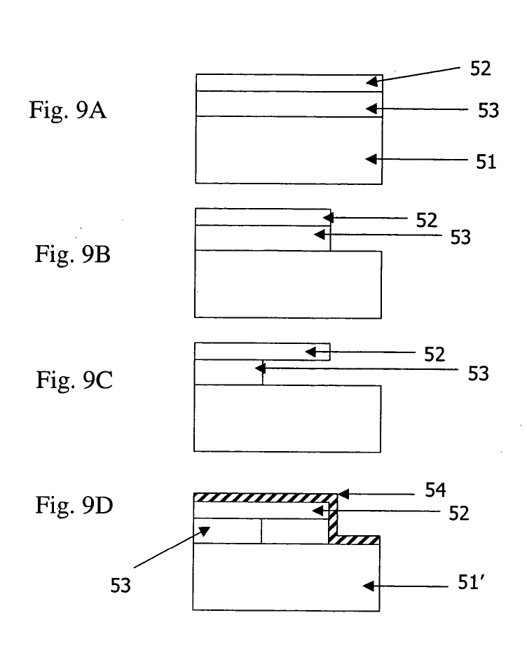

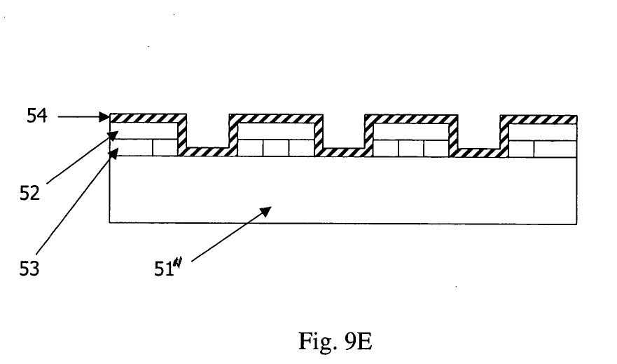

An alternative strategy for forming nano-openings in multilayer heterostructure substrates involves spatially selective removal of layers, etching and thin film deposition. FIGS. 9A through 9E show a schematic of the process for forming these nanochannels. In FIG. 9B, the layered heterostructure 51 is processed, e.g. with a finely focused ion beam (FIB), to remove the top a-Si barrier layer 52 and the middle SiO₂ channel layer 53 creating a region that exposes the channel layer. The FIB milled features can be any geometry including points, lines, curves, and rectangles. In addition, the depth for the FIB milling does not have to be as precise as shown in the figure but can under or overshoot so long as the channel layer is exposed. Other techniques for removal of the outer barrier layer could also be used, e.g., photolithographic or e-beam patterning of a resist, followed by dry or wet etching. FIB milling is a preferred method for high spatial resolution removal of layer materials. In FIG. 9C, the exposed channel layer 52 is selectively etched creating a groove similar to the groove observed in FIG. 8. An enclosed channel is then formed by depositing a thin film 54 of material, e.g., SiO₂, on top of the structure. The completed structure is designated 51′. In order to enclose the etched groove, the film preferably is slightly thicker than the height of the middle oxide layer. Depending on the material, this thin film can be deposited by a number of techniques including magnetron sputtering and pulsed laser vapor deposition. The depth of the nanochannel is controlled by the thickness of the heterostructure channel layer, and its width is controlled by the etch rate and time for the channel layer as described above. There are a variety of materials besides the Si/SiO₂/Si system that can be used for the layered heterostructures so long as the channel layer can be etched or removed preferentially compared to the top and bottom barrier layers. These materials include metals, semiconductors, dielectrics, and polymers. An interesting example is using the same system of Si and SiO₂ in a different order, SiO₂/Si/SiO₂, to allow optical access to the nanochannels, if necessary.

In FIGS. 9A-9D, a single nanochannel is fabricated. However, arrays of nanochannels can be formed as seen at 51″ in FIG. 9E. As depicted, the pattern is simply replicated creating two nanochannels for each region of material removed by the FIB milling. The spacing between adjacent nanochannels in FIG. 9E depends on the width of the FIB milled pattern and the etching of the middle layer.

An alternative to FIB milling is to use electron beam or photolithography and chemical etching to expose the middle layer. The top layer is formed as a channel layer. A resist mask is placed on top of the top layer and used to transfer the pattern of interest onto the substrate. After developing the resist, the top layer is etched to expose the middle barrier layer. The middle layer is then etched and undercuts the top layer. The resulting structure is similar to FIG. 9C. Subsequently, the thin film can be deposited on the structure yielding a nanochannel similar to FIG. 9D.

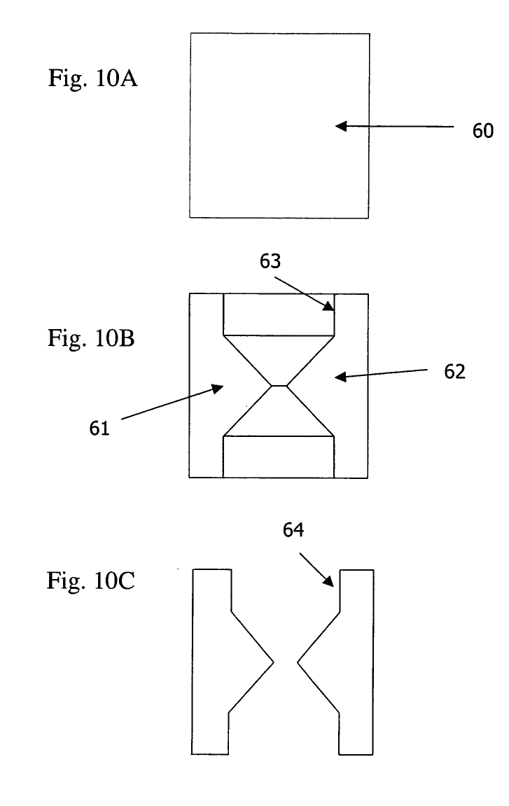

In this embodiment, the width of the nanochannel is determined by the etch rate and etch time of the channel layer. An alternative method is to define the width of the channel by patterning boundaries using either FIB milling or lithography between which the middle layer is completely removed. FIGS. 10A through 10C depict the process for creating a nanometer scale orifice where the FIB milling defines the width of the nanochannel. FIG. 10A shows the top view of a heterostructure 60 prior to milling. In FIG. 10B, selected areas 61 and 62 of the top and middle layers are removed using FIB milling. The middle layer is then selectively etched from underneath the remaining top layer to provide an hour-glass shape 63 in FIG. 10B. The resulting nanochannel 64 with a constriction is shown in FIG. 10C. After etching, a thin film is deposited on top of the structure to seal the edges of the nanochannels (similar to FIG. 9D).

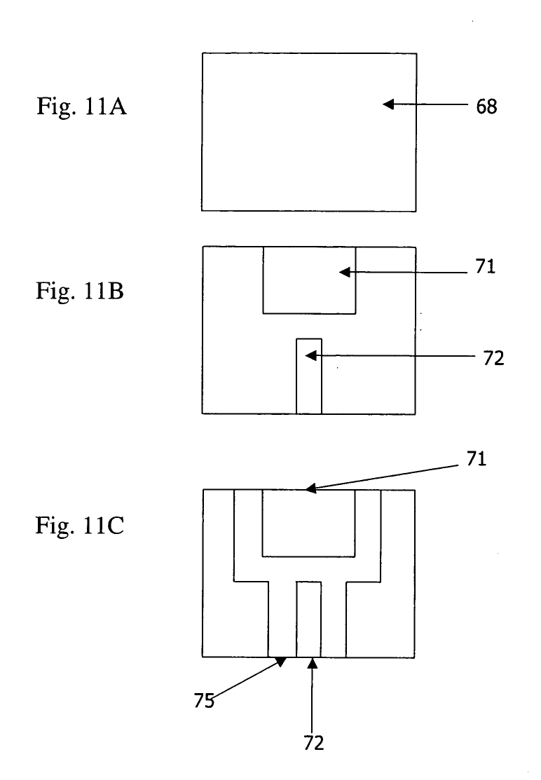

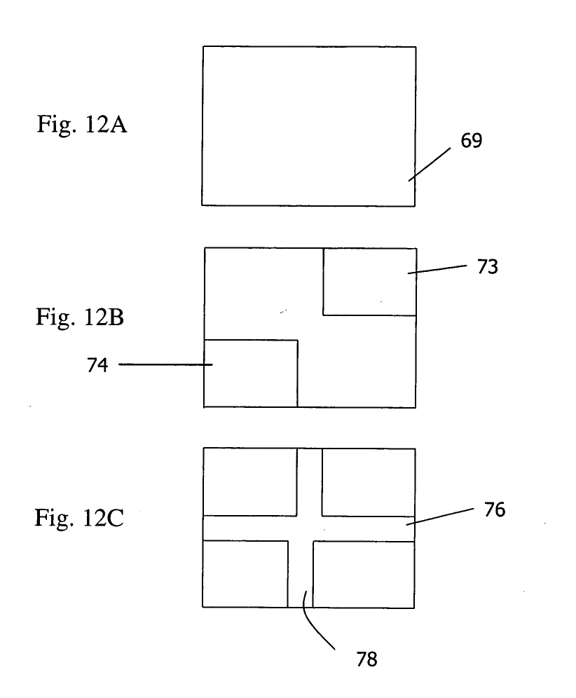

FIGS. 11A through 12C depict tee and cross intersections, respectively, formed using layered heterostructures 68 and 69, FIB milling, and thin film deposition. In these figures, the black areas 71-74 in FIGS. 11B and 12B indicate regions where the top and buried layers have been removed by the FIB milling process. The buried channel layer of the heterostructures 68 and 69 are then etched (white areas in FIGS. 11C and 12C show where the channel layer has been removed by the etching process) to form the grooves 75 and 76 that ultimately become the nanometer scale conduits. A thin film, e.g., SiO₂ (not shown), is then deposited over the entire structure to enclose the nanochannels. A double tee intersection 75 is formed in FIG. 11, and a cross intersection 76 in FIG. 12. For the cross intersection, the width of the intersecting nanochannels is defined by the FIB milling. FIB milling can also be used to further process the device after etching the buried layer and prior to depositing the thin film. For example, in FIG. 11C, one channel of the double tee intersection can be sectioned off to form a single tee intersection by milling through the top layer and exposing the etched buried layer. During deposition of the thin film, this post milled area is filled with the deposited material blocking fluid access to that channel. The nanochannel architectures are not limited to the tee and cross intersections. In addition, these structures can be coupled to microchannels to introduce fluids and samples. To connect to the micro- and nanochannels, the FIB is used to mill access holes at the termini of the nanochannels, one of which is indicated at broken lines 78 in FIG. 12C. A microchannel structure or other connection to a reservoir will then be overlaid to deliver materials to the nanochannels.

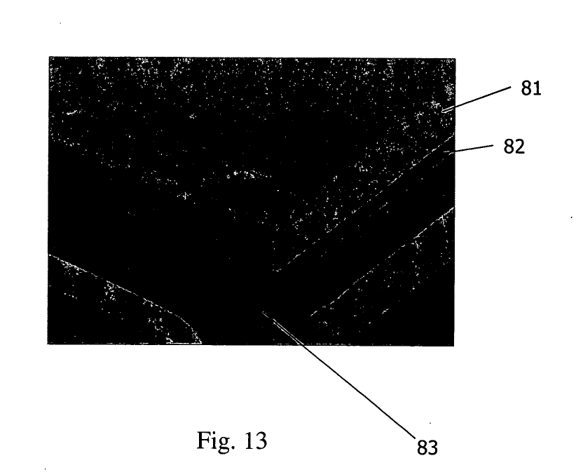

An example of this strategy for forming nano-openings in multilayer heterostructures is shown in FIG. 13. The substrate is a Si:SiO₂:Si wafer formed using the SIMOX process. The top Si (barrier) and SiO₂ (channel) layers 81 and 82 have thicknesses of 2 μm and 1 μm respectively. A region of the wafer was FIB milled to expose the channel layer at a square edge 83. The sectioned wafer was then etched by wet chemical etching using a buffered HF solution to a depth of 2.5 μm. The etched heterostructure was then imaged using secondary electron emission in the FIB device to produce the image shown in FIG. 13 which reveals the removal of the channel layer.

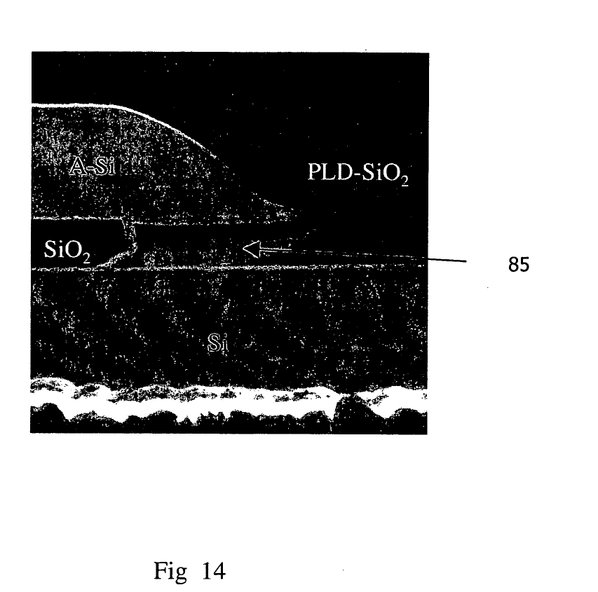

FIG. 14 shows a secondary electron image of the etched SIMOX wafer after deposition of an SiO₂ film and FIB sectioning to reveal the resulting closed channel. The SiO₂ film was deposited using pulsed laser deposition (PLD). The PLD device is a commercial instrument available from PVD Products, Inc. In the PLD process for glass deposition, a silicon monoxide target is ablated in an oxygen atmosphere using a Kr—F excimer laser, 400 mJ per pulse, 25 hz repetition rate, with the SOI substrate at room temperature. Film stoichiometry is controlled by adjusting the partial pressure of oxygen, which interacts with the vaporized target material to form SiOₓ. Film thickness is controlled by varying the total number of laser pulses during a deposition procedure. A buried channel is formed with the walls consisting of the bottom Si substrate, top amorphous Si, left wall is SiO₂ of heterostructure, and the right wall is formed from the deposited amorphous SiO₂. For the example in FIG. 14, 3.5 μm of silicon oxide was deposited on the etched heterostructure.

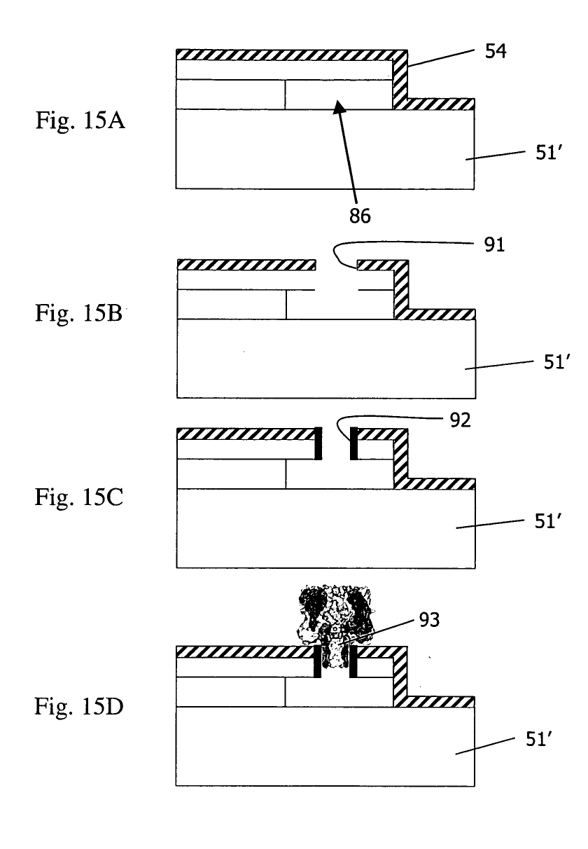

An example demonstrating the utility of being able to form a buried channel feature is now given. In this example the goal is to fabricate an array of nanopore sensors for chemical detection purposes or for drug candidate screening. The processes that must be completed to form the nanopore, modify the nanopore and insert a chemical sensing molecular assembly, such as an ion channel, are schematically depicted in FIGS. 15A through 15D. The starting point is the buried channel structure 51′ from FIG. 9D. The FIB is used to mill a nanoscale orifice 91 through the cover layer 54 and the top layer 52 of the heterostructure 51′. Argon ion implantation can potentially be used to close the pore relative to the FIB results to as small as 5 nm, as has been shown by others. We will attempt to further reduce the dimensions of the orifice and to create a low energy well for a synthetic ion channel by making the nanopore environment hydrophobic, for example by coating the orifice with a molecular film, as indicated at 92 in FIG. 15C. The final step of the process is inserting a protein assembly 93 which serves as a single ion channel into this orifice.

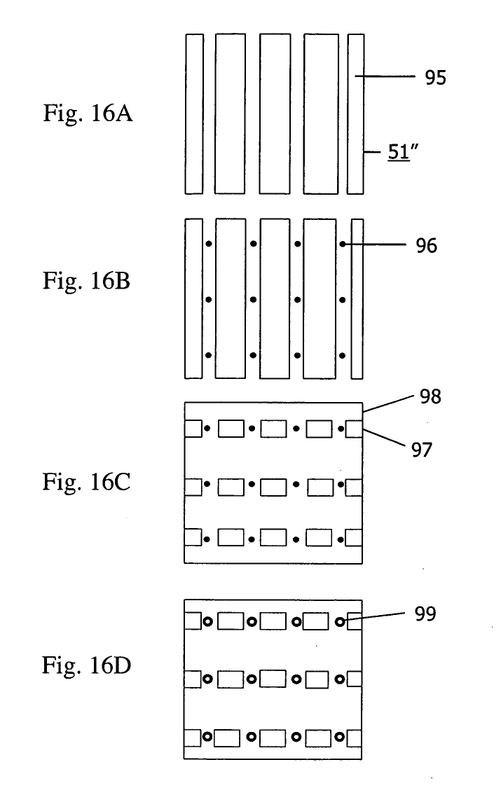

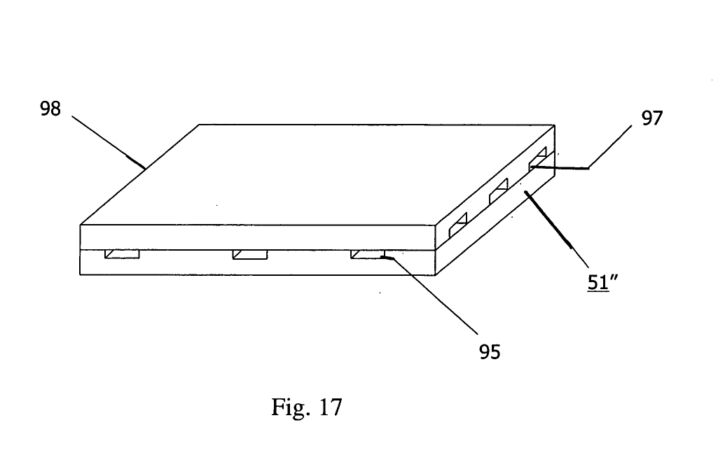

Individually addressable arrays of these ion channel nanopore sensors can be fabricated using the technique described in this application. FIG. 16 schematically depicts how such an array device would be fabricated. Parallel arrays of buried channels 95 would first be formed in a multilayer heterostructure 51″ as illustrated in FIG. 9E and depicted in FIG. 16A. An array of nanopores 96 is then milled through the cover layers of the buried channel device as shown in FIG. 16B. The spacing between the nanopores is sufficiently large that they can be individually addressed by orthogonal microchannels 97 formed in a cover member 98 that is bonded over top the nanopore array. A perspective view of the assembly shown in FIG. 16C is shown in FIG. 17. The buried channel features formed in the multilayer heterostructure 51″ are in a different plane of the device than the microchannels in the cover member 97. The spacing of the nanopores and the cover member microchannels can be designed such that only a single nanopore 96 connects any given buried channel 95 and cover a number of channels 97. Ion channels or other nanopore sensing elements 99 can be delivered to the nanopores 96 through the cover member microchannels. Delivery of specific nanopore sensing elements can be achieved by electrically biasing the individual nanopores in a given channel so that the target nanopore attracts the sensing element while all other nanopores are biased to repel the sensing element. After a sensing element is inserted into a nanopore, the microchannel can be filled with a different sensing element and another nanopore biased for insertion of the new sensing element.

Such nanopore sensors are interrogated by electrically biasing the nanopore and monitoring the current. An individual nanopore within the array can be monitored by applying a bias voltage between individual orthogonal channels. It should be noted that an entire row or column of nanopores can be simultaneously biased and monitored by applying a voltage between all rows or all columns and an individual column or row, respectively.

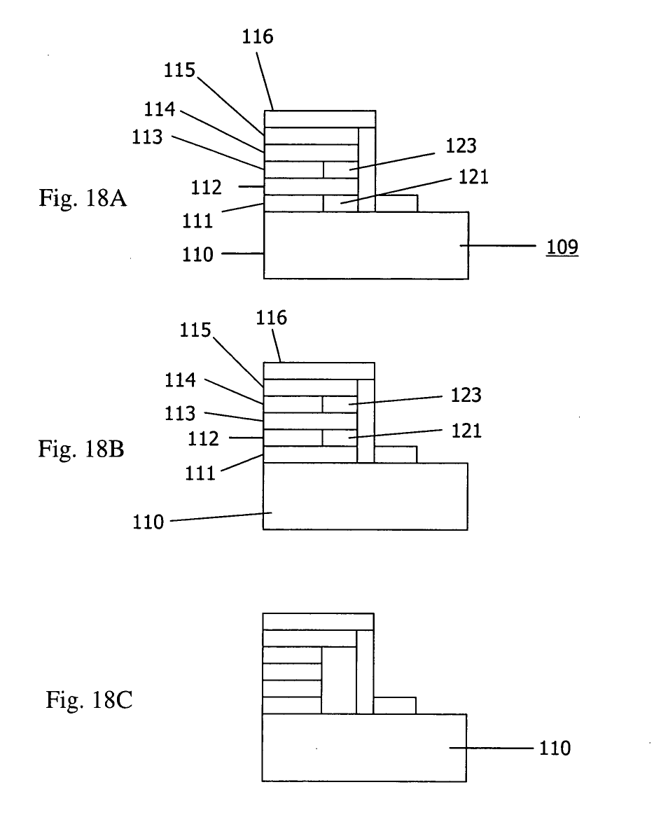

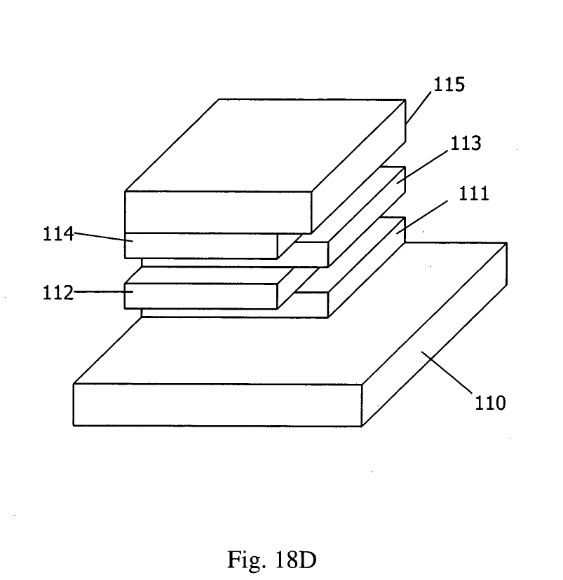

FIGS. 18A through 18C show a three-dimensional nanofluidic heterostructure 109. As depicted, the structure consists of a substrate 110 with six layers on top of the substrate. Five layers are a stacked multilayer heterostructure, and layer 116 is a deposited thin film. Layers 111 and 113 are similar materials, and layers 112 and 114 are similar materials. Layers 111 and 113 should have different etching properties than layers 112 and 114, and layer 115 different from layers 111-114. In FIG. 18A (similar to FIGS. 9D and 9E) the FIB is used a first time to mill through layers 111-115, and layers 111 and 113 are selectively etched relative to layers 112, 114, and 115. Layer 116 is then deposited to form channels 121 and 123 in layers 111 and 113. In FIG. 18B, the FIB is used a second time to mill through layers 111-115, and layers 112 and 114 are selectively etched relative to layers 111, 113, and 115. Layer 116 is then deposited to form channels 122 and 124 in layers 112 and 114. Where the first and second FIB milling intersect, conduits are formed between adjacent layers (see FIGS. 18C and 18D) allowing fluid communication between layers of nanochannels. FIG. 18D shows a perspective view of the etched multilayer heterostructure without layer 116 present. The forward right-hand portion of the multilayer heterostructure shows fluid communication existing between layers 111-114. Although a 5 layer heterostructure is shown, this technique can be used for fabricating devices with 2 to N layers of nanochannels using 3 to N+1 layer heterostructures.

The subject matter in the references cited in our copending U.S. application Ser. No. 10/629,790 is incorporated in the application by reference.

While particular embodiments of the present invention have been illustrated and described, the invention is not limited to the specific disclosures embodied herein.

1. A method of producing a small-scale flow channel in a mesoscale analytic device, comprising the steps of providing a solid multi-layered heterostructure with an exposed surface exposing the multiple layers of said heterostructure, one of said multiple layers comprising a channel layer sandwiched between adjoining barrier layers, said channel layer consisting of a thin-film of a material of different composition than the adjoining barrier layers, said thin film having a defined small-scale thickness, and
microfabricating a channel in said exposed surface as a groove by etching away said intermediate layer to a preselected depth, said groove having a bottom wall spaced below said surface by said preselected depth, and opposed side walls defined by said adjacent barrier layers, to thereby form a small-sale flow channel in the exposed surface.

2. A method according to claim 1 including the step of selecting the preselected depth by controlling the conditions and duration of the etching away.

3. A method according to claim 1 wherein said solid substrate comprises two blocks of silicon spaced apart by a thin-film layer of SiO₂, and said microfabricating step is effected by chemically etching away said layer to a depth which forms said groove.

4. A method according to claim 1 for producing a closed small-scale flow conduit including the further step of applying a cover member to said exposed surface, said cover member overlying said groove to thereby close the top of said small-scale flow channel to form a closed small-scale flow conduit.

5. A method according to claim 1 for producing a closed small-scale flow channel of predetermined length including the further steps of
polishing the exposed surface to a mirror finish,
applying masking material to the polished surface to define the predetermined length therebetween prior to etching away said channel layer,
after etching away said channel layer removing said masking material, and
bonding a planar cover member to said polished exposed surface, said cover member overlying said groove to thereby close the top of said small-scale flow channel to form a closed small-scale flow conduit of said predetermined length.

6. A method according to claim 1 for producing a plurality of interconnected small-scale flow channels having a tee junction in a mesoscale analytic device, wherein said heterostructure has an end surface, and said flow channel in the exposed surface extends intersects said end surface, including the further steps of
providing a second solid multilayered heterostructure comprising a channel layer providing an end surface, and a barrier layer, said second heterostructure having an exposed second surface exposing said channel layer and said barrier layer of said second heterostructure,
abutting said end surface of said second heterostructure against said end surface of said first heterostructure at a point where said flow channel intersects said surface, with the channel layer of said second heterostructure abutting said second exposed surface and with the exposed second surface of the second heterostructure in alignment with the exposed surface of the first heterostructure, and
etching away the channel layers of said two heterostructure to a predetermined depth to provide intersecting channel grooves in the exposed surfaces of the abutted heterostructures.

7. A method according to claim 1 for producing a and using a small-scale flow channel to filter particles from a fluid, including the further steps of
connecting the opposite ends of said channel to separate fluid reservoirs, and
causing flow of fluid from one of said separate reservoirs to the other of said reservoirs, said small-scale flow channel passing fluids and particles having a transverse cross section smaller than the small-scale flow channel and blocking particles having a transverse cross section larger than the small-scale flow channel.

8. A method of fabricating a die for producing a small-scale flow channel in a mesoscale analytic device, comprising the steps of providing a solid multi-layered heterostructure with an exposed surface exposing the multiple layers of said heterostructure, one of said multiple layers comprising a barrier layer sandwiched between two adjoining channel layers, at least said barrier layer consisting of a thin-film of a material of different composition than the adjoining channel layers, said thin film having a defined small-scale thickness, and
microfabricating channels in said exposed surface by etching away said channel layers to a preselected depth to produce recesses on opposite sides of a protrusion, said recesses having bottom walls spaced below said surface by said preselected depth, to thereby form a protrusion having a projection corresponding to said preselected depth, opposed side walls defined by said recesses, and width corresponding to said defined small-scale thickness.

9. A method according to claim 8 including the step of selecting the preselected depth by controlling the conditions and duration of the etching away.

10. A method according to claim 8 wherein said solid substrate comprises two blocks of SiO₂ spaced apart by a thin-film layer of silicon, and said microfabricating step is effected by chemically etching away said SiO₂ layers to a depth which forms said recesses.

11. For use in analyzing a fluid medium having components with differing transverse cross sectional area, a mesoscale analytic device having a small-scale flow channel comprising a a solid multi-layered heterostructure with an exposed surface exposing the multiple layers of said heterostructure, one of said multiple layers comprising a channel layer sandwiched between two adjoining barrier layers, at least said channel layer consisting of a thin-film of a material of different composition than the adjoining barrier layers, said thin film having a defined small-scale thickness,
a flow channel in said heterostructure having a bottom wall spaced below said exposed surface and being of the material constituting said channel layer, and opposed side walls being of the material constituting the barrier layers, said flow channel having a cross-sectional flow area defined by the spacing between said opposed sidewalls and the depth of said bottom wall below said uncovered surface. and
a cover member on said upper surface overlying said groove to thereby close the top of said small-scale flow channel.

12. A mesoscale analytic device according to claim 11 wherein said heterostructure includes a microchannel communicating with said coated small-scale flow channel, whereby flow from said microchannel into said small-scale flow channel is restricted to components of said fluid medium having a transverse cross-sectional area smaller than said small-scale flow area.

13. A mesoscale analytic device according to claim 12 wherein said fluid medium includes include molecular components of differing size, said microchannel having a cross-sectional area larger than all of the molecules in said fluid medium, and said small-scale channel is larger than at least one of said molecular components and is smaller than other of said molecular components.

14. A mesoscale analytic device according to claim 11 wherein said barrier layer consist of silicon and said channel layer consists of a thin-film layer of SiO₂.

15. A die for fabricating a mesoscale analytic device having a small-scale flow channel, comprising a a solid multi-layered heterostructure with an exposed surface exposing the multiple layers of said heterostructure, one of said multiple layers comprising a barrier layer sandwiched between two adjoining channel layers, at least said barrier layer consisting of a thin-film of a material of different composition than the adjoining barrier layers, said thin film having a defined small-scale thickness,
recesses in said heterostructure, each having a bottom wall spaced below said exposed surface and being of the material constituting said channel layers, and at least one side walls being of the material constituting the barrier layer, and a protrusion between said recesses, said protrusion having a cross-sectional area defined by the spacing between said sidewalls and the depth of said bottom walls below said exposed surface. and
a cover member on said upper surface overlying said groove to thereby close the top of said small-scale flow channel.

16. A die according to claim 15 wherein said barrier layer consist of silicon and said channel layer consists of a thin-film layer of SiO₂.
